(19) United States
(12) Patent Application Publication
(10) Pub. No.: US 2009/0185637 A1
(43) Pub. Date: Jul. 23, 2009

(54) APPARATUS AND CIRCUIT FOR DATA TRANSMISSION

(75) Inventors: Masahiko MAWATARI, Kanagawa (JP); Takashi DOI, Tokyo (JP); Hideki OHKITA, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/204,261

(22) Filed: Sep. 4, 2008

(30) Foreign Application Priority Data
Jan. 17, 2008 (JP) 2008-008437

(51) Int. Cl. H04L 27/00

(52) U.S. Cl. 375/295

(57) ABSTRACT

The invention provides a data transmitting apparatus including: a data transmitting circuit (100) having a differential signal line through which a differential signal is transmitted/received by a first line (161, 165) through which hot plug detection information of a communication line is transmitted, and a second line (162, 167) paired with the first line (161, 165), a hot plug-driving portion (158) for driving a signal on the first line (161, 165) so that a level of the signal is changed either to an L level or to an H level, and a differential communicating portion (168, 169) connected to the differential signal line for transmitting the differential signal, the differential communicating portion (168, 169) being operated in an operable range when the level of the signal on the first line (161, 165) is changed from the L level to the H level and from the H level to the L level by the hot plug driving portion; and a signal processing portion for executing signal processing for the differential signal which is transmitted/received through the data transmitting circuit (100).

### CROSS-REFERENCE TO RELATED APPLICATIONS

The present application is based on and claims the benefit of priority from Japanese patent application No. 2008-008437, filed Jan. 17, 2008, the entire contents of which are incorporated herein by reference.

### BACKGROUND

1. Field

One embodiment of the invention relates to a data transmitting apparatus and a data transmitting circuit.

2. Description of the Related Art

The High Definition Multimedia Interface (HDMI) standard is known as an example regulated for a multimedia interface between a video transmitting apparatus such as a Digital Versatile Disc (DVD) player or a set-top box, and a video receiving apparatus such as a Television (TV) receiver-monitor. An apparatus having an HDMI output terminal is referred to as a source apparatus, and an apparatus having an HDMI input terminal is-referred to as a sink apparatus. Thus, the video transmitting apparatus is the source apparatus, while the video receiving apparatus is the sink apparatus. In addition thereto, an apparatus which has both the HDMI input terminal and the HDMI output terminal, and which has both the functions of the source apparatus and the sink apparatus is referred to as a repeater apparatus.

When the source apparatus is connected to the sink apparatus, a power source signal having +5 V is transmitted from the source apparatus to the sink apparatus for the purpose of informing the sink apparatus of connection between the source apparatus and the sink apparatus. For this reason, the power source signal having +5 V is also a signal representing source ready.

When receiving the power source signal having +5 V, the sink apparatus starts to prepare for reception of a video signal. Upon completion of the preparation for reception of the video signal, the sink apparatus transmits a Hot Plug Detection (HPD) signal (High signal) to the source apparatus. Thus, the HPD signal is also a signal representing sink ready.

The sink apparatus includes an Extended Display Identification Data (EDID) memory for storing therein EDID containing therein video format information which can be displayed by the sink apparatus. The video format information contains therein a display specification about a format and resolution of video data, a display specification about a synchronous frequency and the like, and audio specification data such as a format, a sampling frequency Fs, and a bit length of audio data.

When receiving the HPD signal having the High level, the source apparatus reads out the EDID from the EDID memory of the sink apparatus through a Display Data Channel (DDC) line, and reads the video format information which is written in the EDID and which can be displayed by the sink apparatus.

In addition, the source apparatus exchanges data required for authentication of High-bandwidth Digital Content Protection (HDCP) with the sink apparatus through the DDC line. Although HDCP key information, for example, is known as the data required for the authentication of the HDCP, it is assumed in this example that the HDCP key information is stored in a storage region of the sink apparatus. The authentication means that the source apparatus confirms that the sink apparatus has an authority to receive the video signal. When the authentication is effected, the source apparatus enciphers the video signal by using a secret key shared with the sink apparatus, and transmits the video signal thus enciphered to the sink apparatus.

After completion of the reading-out of the EDID, and the authentication of the HDCP, the source apparatus transmits the video signal, the audio signal, and AUX information which are adapted for the format in the sink apparatus to the sink apparatus by using a Transition Minimized Differential Signaling (TMDS) system.

The standard about interdependent control called Consumer Electronics Control (CEC), and carried out between the apparatuses is also regulated in the HDMI standard. The HDMI apparatuses are connected to one another in a tree-like shape through the repeater. The CEC utilizes a single-wire low speed serial bus. A one-touch play with which the sink apparatus is controlled from the source apparatus is known as an example of the functions realized by the CEC. When an operation mode of the source apparatus such as the DVD is set at a reproduction mode (by depressing a reproduction button), the sink apparatus such as the TV receiver is controlled from the source apparatus to be automatically turned ON as may be necessary, and a signal path is automatically set on the auto-apparatus (such as the DVD player) side, thereby providing a state in which the reproduced image can be displayed on the sink apparatus.

There is proposed a communication system in which by utilizing a method of transmitting/receiving data complying with the HDMI standard, not only the data is transmitted from the source apparatus to the sink apparatus, but also the data is transmitted from the sink apparatus to the source apparatus, thereby making it possible to carry out high speed two-way communication. This communication system, for example, is described in the Japanese Patent Kokai No. 2007-311884.

In the communication system described in the Japanese Patent Kokai No. 2007-311884, a communicating portion for communication from a receiver to a transmitter is provided in at least one of TMDS data channels, and data is transmitted from the receiver to the transmitter in accordance with a time division system in an unused section in which no data is transmitted from the transmitter to the receiver.

According to the communication system described in the Japanese Patent Kokai No. 2007-311884, controlling not only a transmission timing at which the data is transmitted from the transmitter to the receiver, and but also a transmission timing at which the data is transmitted from the receiver to the transmitter results in that the high speed two-way communication can be carried out while there is kept the interchangeability in the transmission/reception of the data complying with the HDMI standard.

In addition, there is proposed a display device which detects an HPD signal, and reads out or writes data in accordance with a signal level of the HPD signal when there is controlled the transmission/reception of data complying with the HDMI standard. This display device, for example, is described in the Japanese Patent Kokai No. 2007-226251.

With the display device described in the Japanese Patent Kokai No. 2007-226251, when an HPD signal is set at an “H” level, information recorded in a memory of the display device can be read out to the DVD player side through a communication interface (HDMI).

However, the communication system described in the Japanese Patent Kokai No. 2007-311884 involves such a problem that the two-way data transmission can not be performed at an arbitrary timing because the data transmission is carried out in accordance with the time division system by using the TMDS data channel when the high speed two-way communication is carried out.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an overall view showing a data transmitting system according to a first embodiment of the invention;

FIG. 2 is a block diagram schematically showing the data transmitting system according to the first embodiment of the invention;

FIG. 3 is a schematically configurational view partly showing a data transmission path in the data transmitting system according to the first embodiment of the invention;

FIG. 4A is a circuit diagram partially showing an information transmission path shown in FIG. 3 of the data transmitting system according to the first embodiment of the invention;

FIG. 4B is a circuit diagram partially showing an information transmission path including an existing hot plug detection circuit;

FIG. 5A is an overall view showing a data transmitting system according to a second embodiment of the invention;

FIG. 5B is an overall view showing an example of a data transmitting system having no communication line existing therein described in the first embodiment; and

FIG. 6 is an overall view showing a data transmitting system according to a third embodiment of the invention.

### DETAILED DESCRIPTION OF PREFERRED EMBODIMENTS

Various embodiments according to the invention will be described hereinafter with reference to the accompanying drawings. In general, according to one embodiment of the invention, there is provided a data transmitting apparatus, including: a data transmitting circuit having a differential signal line through which a differential signal is transmitted/received by a first line through which hot plug detection information of a communication line is transmitted, and a second line paired with the first line, a hot plug-driving portion for driving a signal on the first line so that a level of the signal is changed either to an L level or to an H level, and a differential communicating portion connected to the differential signal line for transmitting the differential signal, the differential communicating portion being operated in an operable range when the level of the signal on the first line is changed from the L level to the H level and from the H level to the L level by the hot plug driving portion; and a signal processing portion for executing signal processing for the differential signal which is transmitted/received through the data transmitting circuit.

According to a further embodiment of the invention, there is provided a data transmitting circuit, including: a differential signal line through which a differential signal is transmitted/received by using a first line through which hot plug detection information of a communication line is transmitted, and a second line paired with the first line; a hot plug driving portion for driving a signal on the first line so that a level of the signal is changed either to an L level or to an H level; and a differential communicating portion connected to the differential signal line for transmitting the differential signal; in which the differential communicating portion is operated in an operable range when the level of the signal on the first line is changed from the L level to the H level and from the H level to the L level by the hot plug driving portion.

According to the invention, the high speed two-way communication can be carried out at an arbitrary timing.

Hereinafter, embodiments of the invention will be described in detail with reference to the accompanying drawings.

### First Embodiment

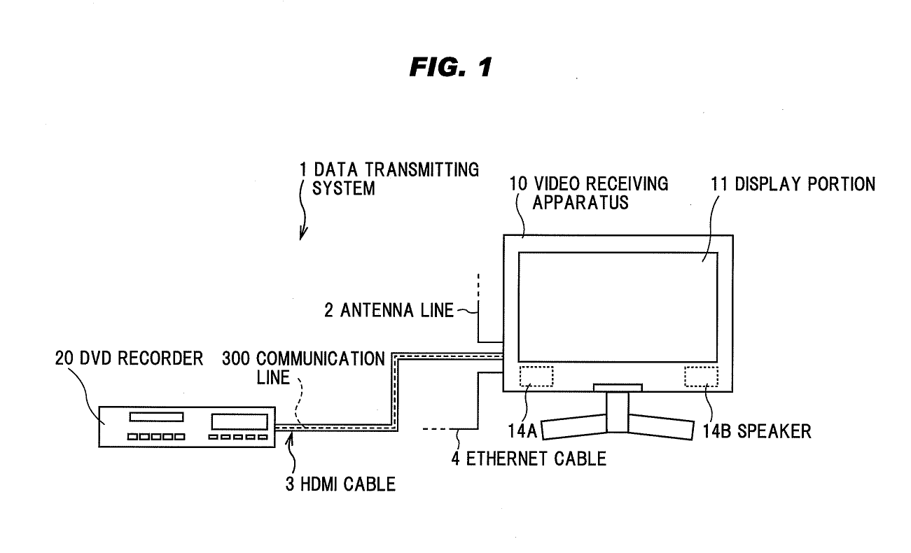

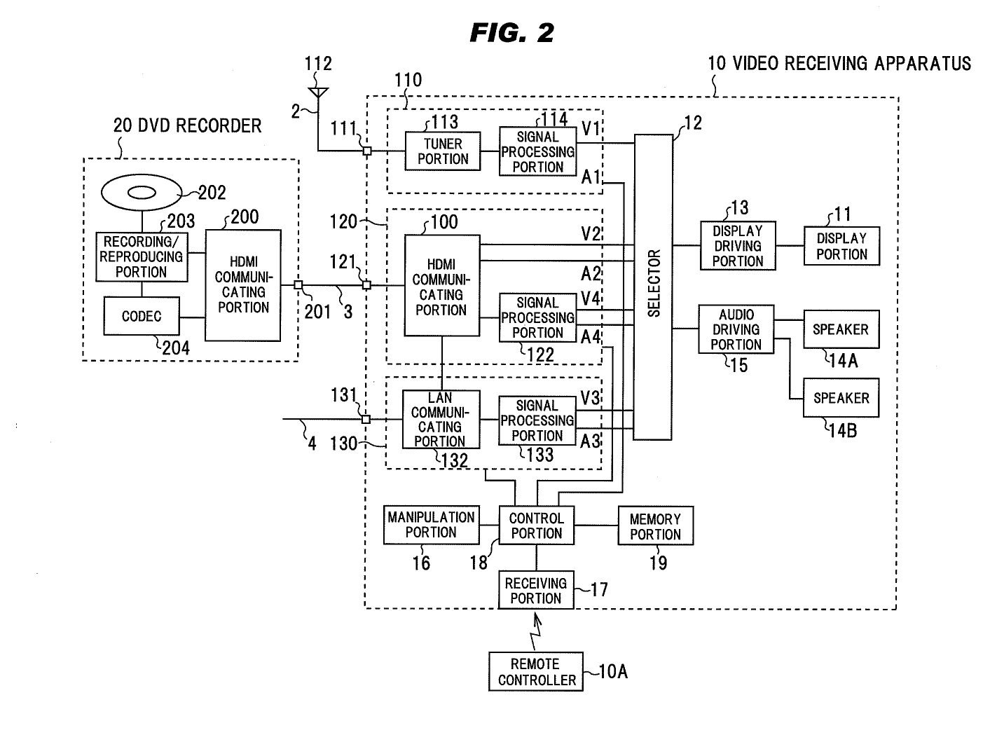

FIG. 1 is an overall view showing a data transmitting system according to a first embodiment of the invention. The data transmitting system 1 is composed of a video receiving apparatus (TV set) 10 as a sink apparatus in this embodiment, a DVD recorder 20 as a source apparatus, and an HDMI cable 3 through which the video receiving apparatus 10 and the DVD recorder 20 are connected to each other, thereby making it possible to carry out high speed two-way communication. In addition, the HDMI cable 3 includes a communication line 300 through which data can be transmitted from the sink apparatus to the source apparatus at a high speed and at an arbitrary timing. Also, an antenna line 2 connected to an antenna 112 (refer to FIG. 2), and an Ethernet (registered trademark) cable 4 connected to the Internet Protocol (IP) communication network are connected to the video receiving apparatus 10.

The video receiving apparatus 10 reproduces data, on an image and a sound from a DVD installed in the DVD recorder 20, which is transmitted thereto through the HDMI cable 3. In addition, the video receiving apparatus 10 outputs an image and a sound based on a television broadcasting signal received at the antenna to which the antenna line 2 is connected. Also, the video receiving apparatus 10 outputs an image and a sound based on a signal, complying with the Internet Protocol Television (IPTV), which is received through the Ethernet (registered trademark) cable 4.

In addition, the video receiving apparatus 10 can transmit the data based on the television broadcasting signal described above, the data complying with the IPTV, and the like to the DVD recorder 20 at a high speed through the communication line 300 included in the HDMI cable 3.

FIG. 2 is a block diagram schematically showing the data transmitting system according to the first embodiment of the invention.

The video receiving apparatus 10 includes a television functional portion 110 for receiving a television broadcasting signal, an HDMI functional portion 120 for receiving a digital video signal complying with the HDMI standard, a Local Area Network (LAN) functional portion 130 for receiving a signal, complying with the IPTV, which is transmitted thereto through the Ethernet (registered trademark) cable 4, a selector 12 for selecting a suitable output from outputs of the television functional portion 110, the HDMI functional portion 120, and the LAN functional portion 130, a display driving portion 13 for instructing a display portion 11 to display thereon an image based on a video signal outputted from the selector 12, an audio driving portion 15 for instructing each of speakers 14A and 14B to output a sound based on an audio signal outputted from the selector 12, a manipulation portion 16 for performing an input manipulation based on a manual operation made by a user, a receiving portion 17 for receiving a remote-control operation signal transmitted from a remote controller 10A in accordance with an input manipulation made by the user, a control portion 18 for generally controlling the television functional portion 110, the HDMI functional portion 120, and the LAN functional portion 130 of the video receiving apparatus 10, and a memory portion 19 including a read-only memory in which a control program is stored which a CPU of the control portion 18 executes, a read/write memory for providing a work area for the CPU, and a nonvolatile memory in which various setting information, control information, and the like are stored.

The television functional portion 110 includes a tuner portion 113 for receiving the television broadcasting signal at the antenna 112 connected to a Television (TV) input terminal 111 through the antenna line 2, and extracting a signal of a predetermined channel, and a signal processing portion 114 for restoring an analog video signal V1 and an analog audio signal A1 from the received signal outputted from the tuner portion 113.

The HDMI functional portion 120 includes an HDMI communicating portion 100 connected to an HDMI terminal 121 for separating a digital video signal, complying with the HDMI standard, which is received from the DVD recorder 20 through the HDMI terminal 121 into a video component and an audio component. Also, the HDMI functional portion 120 outputs the video component and the audio component which are outputted from the HDMI communicating portion 120 in the form of an analog video signal V2 and an analog audio signal A2, respectively. In addition, the HDMI communicating portion 120 includes a signal processing portion 122 for separating a video signal based on the differential signal received in a communicating portion 160 which will be described later and which is provided in the HDMI communicating portion 100 into a video component and an audio component, and outputting the resulting video component and audio component in the form of a video signal V4 and an audio signal A4, respectively. The HDMI cable 3 is connected as a digital transmission bus which is connected to the HDMI terminal 201 of the DVD recorder 20 to the HDMI terminal 121.

The LAN functional portion 130 includes a LAN communicating portion 132 for receiving an IPTV broadcasting signal through the Ethernet (registered trademark) cable 4 connected to the LAN terminal 131, and extracting a signal of a predetermined channel, and a signal processing portion 133 for restoring a received signal outputted from the LAN communicating portion 132 to an analog video signal V3 and an analog audio signal A3.

The selector 12 has a function of selectively switching the analog video signal V1 and the analog audio signal A1 outputted from the television functional portion 110, the analog video signal V2 and the analog audio signal A2 outputted from the HDMI functional portion 120, and the analog video signal V3 and the analog audio signal A3 outputted from the LAN functional portion 130 over to one another, and outputting the analog video signal and the analog audio signal obtained through the selective switching to a display driving portion 13 and an audio driving portion 15, respectively.

The DVD recorder 20 includes an HDMI communicating portion 200 having a communicating portion 260 which will be described later and which carries out high speed two-way data transmission with the HDMI communicating portion 100 of the video receiving apparatus 10 through the HDMI cable 3 connected at its output terminal to an HDMI terminal portion 201, a recording/reproducing portion 203 for recording and reproducing data to and from a recording medium 202 such as a DVD, and a codec 204 for MPEG-decoding encoded data supplied thereto from the recording/reproducing portion 203 into a video signal and an audio signal of a base band, and supplying the resulting video signal and audio signal of the base band to the HDMI communicating portion 200. The recording/reproducing portion 203 can record therein the encoded data outputted from the codec 204, or the encoded data outputted from the HDMI communicating portion 200.

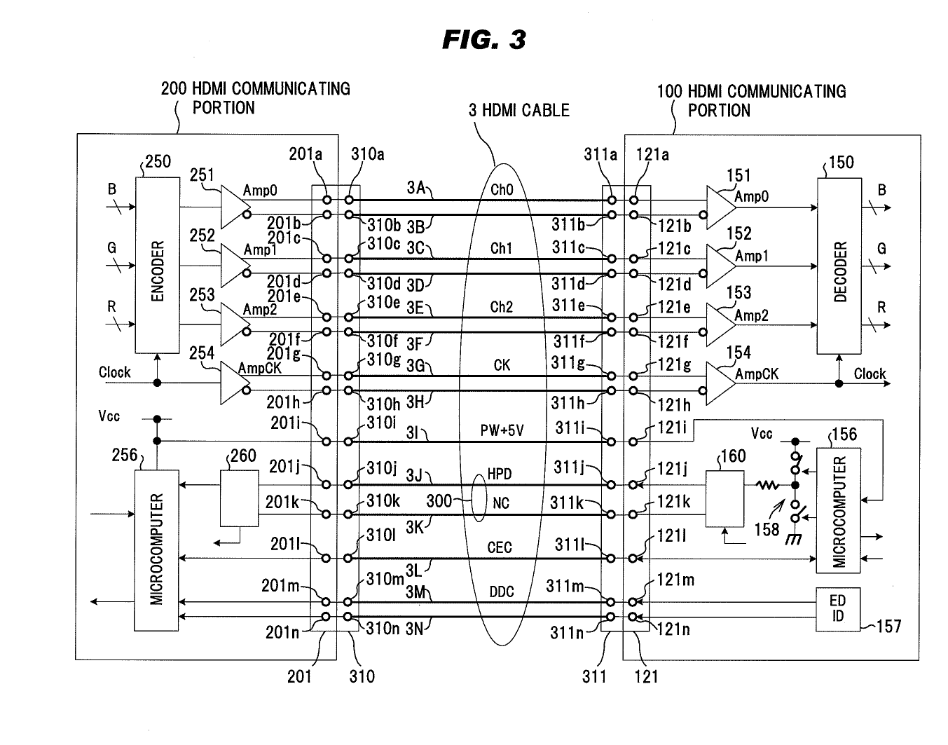

FIG. 3 is a schematically configurational view partly showing a data transmission path in the data transmitting system according to the first embodiment of the invention.

In this embodiment, the data transmission path through which the source apparatus and the sink apparatus are connected to each other is composed of the HDMI communicating portion 200, the HDMI cable 3, and the HDMI communicating portion 100. The data transmission path is also composed of a high speed digital transmission path through which the video signal containing therein the video component and the audio component is transmitted from the source apparatus to the sink apparatus by using three TMDS channels (Ch0, Ch1 and Ch2), and through which a pixel clock with which pixel data transmitted by using the three TMDS channels is synchronized is transmitted by using a CK channel, and an information transmission line including signal lines such as a PW+5V line for representing a cable connection state, an HPD line, a CEC line through which a state of an apparatus is controlled, and a DDC line through which EDIC information is transmitted.

The HDMI communicating portion 200 is provided with a microcomputer 256 for authenticating whether or not the sink apparatus has the authority to receive the video signal.

The HDMI communicating portion 100 is provided with a microcomputer 156, an EDID memory 157 for storing therein video format information which can be displayed by the video receiving apparatus 10 as the sink apparatus in this embodiment, and a switch 158 for switching an H (High) level and an L (Low) level of a voltage of an HPD line 3J over to each other by being driven by the microcomputer 156.

The high speed digital transmission path includes an encoder 250 for encoding 8-bits video signals of R, G and B inputted thereto from the source apparatus into 10-bits serial data of R, G and B, differential amplifiers 251 to 253 for converting the 10-bits serial data of R, G and B obtained through the encoding into differential signals, respectively, a differential amplifier 254 for converting the pixel clock into the differential signal, differential signal lines 3A to 3H through which the differential signals outputted from the differential amplifiers 251 to 254, respectively, are transmitted, differential amplifiers 151 to 154 for decoding the differential signals transmitted through the differential signal lines 3A to 3H, respectively, and received on the sink apparatus side into 10-bits serial data, respectively, and a decoder 150 for decoding the 10-bits serial data into 8-bits video signals, respectively.

The information transmission line includes a PW+5V line 3I through which a power source of the source apparatus, and the microcomputer 156 of the sink apparatus are connected to each other, an HPD line 3J which is connected between the communicating portion 260 of the source apparatus, and the communicating portion 160 of the sink apparatus, and through which information on a connection state of the sink apparatus is transmitted to the source apparatus, an NC line 3K which is used, together with the HPD line 3J, for transmission of the differential signal between the sink apparatus and the source apparatus, a CEC line 3L through which information for interdependent control between the sink apparatus and the source apparatus is transmitted, and DDC lines 3M and 3N through which data required for the HDCP authentication is transmitted between the sink apparatus and the source apparatus.

The HPD line 3J and the NC line 3K constitute the communication line 300 composed of, for example, a twisted pair line, and functions as a two-way digital transmission path through which the differential signal based on a frame complying with the standards of Institute of Electrical and Electronics Engineers (IEEE) 802.3 is transmitted between the source apparatus and the sink apparatus. It is noted that the data transmission using the communication line 300 can also be carried out by utilizing any other suitable transmission system other than the system for transmitting the frame complying with the standard of IEEE802.3 described above.

The HDMI cable 3 is provided such that terminals 310a to 310n, and 311a to 311n which are provided in connectors 310 and 311 so as to correspond to the lines 3A to 3N, respectively, are electrically connected to terminals 201a to 201n, and 121a to 121n corresponding to the HDMI terminal portions 201 and 121, respectively.

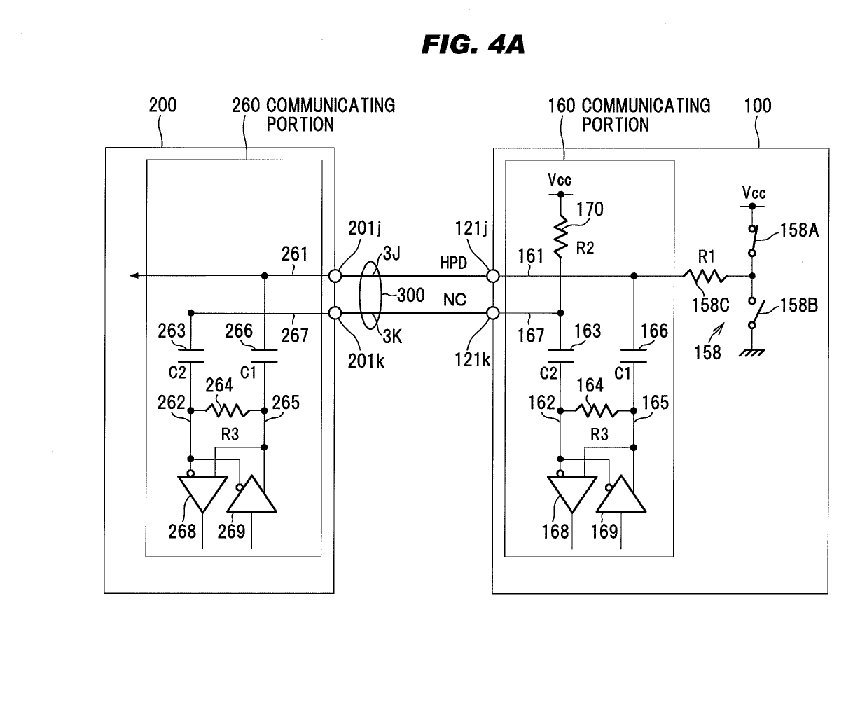

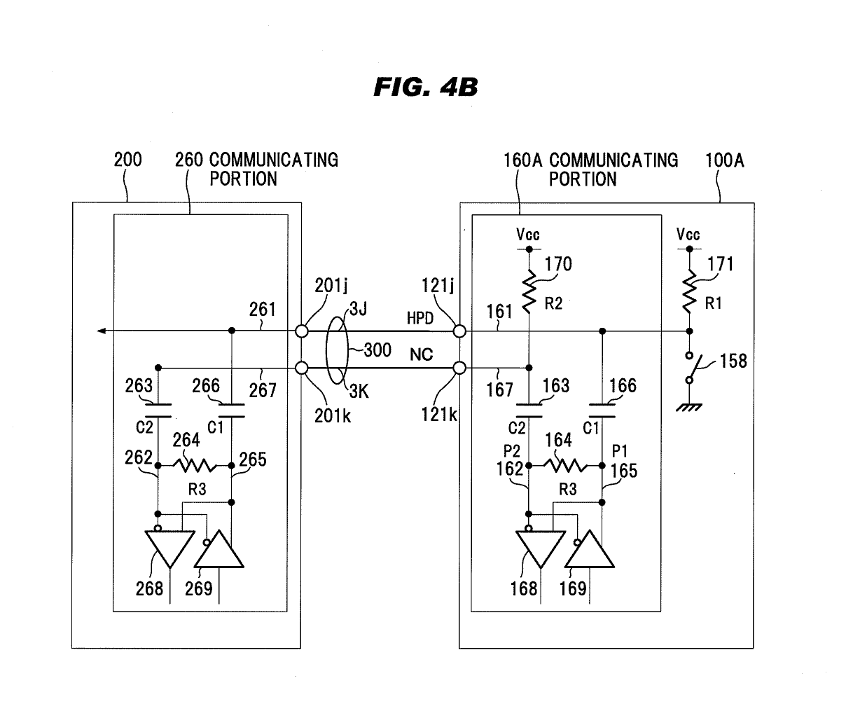

FIG. 4A is a circuit diagram partially showing the information transmission path shown in FIG. 3 of the data transmitting system according to the first embodiment of the invention.

In the communication portion 260, which is previously described, on the source apparatus side, a signal line 261 connected to the terminal 201j of the HDMI terminal portion 201 is also connected to a microcomputer (not shown). The signal line 261 is also connected to the HPD line 3J of the HDMI cable 3. The signal line 261 is also connected to a signal line 265 to the middle of which a capacitor (having a capacitance value C1) 266 is connected. In addition, a signal line 267 connected to the terminal 201k of the HDMI terminal portion 201 is also connected to the NC line 3K of the HDMI cable 3. The signal line 267 is also connected to a signal line 262 to the middle of which a capacitor (C2) 263 is connected. The signal line 262 and the signal line 265 are connected to each other through a resistor (having a resistance value R3) 264. The signal lines 262 and 265 are connected to a receiving amplifier 268 and a transmitting amplifier 269, respectively. It is noted that the receiving amplifier 268 and the transmitting amplifier 269 is connected to signal processing portions (not shown), respectively.

The signal lines 261 and 265, and the signal lines 262 and 267 are paired with each other to constitute a differential signal line for differential transmission. Thus, the signal lines 261 and 265, and the signal lines 262 and 267 are electrically connected to the receiving amplifier 268 and the transmitting amplifier 269, respectively, in order to perform the data transmission through the HPD line 3J and the NC line 3K of the HDMI cable 3.

On the other hand, in the communicating portion 160, which is previously stated, on the sink apparatus side, a signal line 161 connected to the terminal 121j (first terminal) of the HDMI terminal 121 is also connected to the HPD line 3J of the HDMI cable 3. The signal line 161 is also connected to the switch 158 through a resistor (R1) 158C. The resistor (R1) 158C and the switch 158 are provided outside the communicating portion 160. The signal line 161 is also connected to a signal line 165 to the middle of which a capacitor (C1) 166 is connected. In addition, a signal line 167 connected to the terminal 121k (second terminal) of the HDMI terminal portion 121 is also connected to the NC line 3K of the HDMI cable 3. The signal line 167 is connected not only to a power source V_{cc} through a resistor (R2) 170, but also to a signal line 162 to the middle of which a capacitor (C2) 163 is connected. The signal line 162 and the signal line 165 are connected to each other through a resistor (R3) 164. Also, the signal line 162 and the signal line 165 are connected to a receiving amplifier 168 and a transmitting amplifier 169, respectively. It is noted that the receiving amplifier 168 and the transmitting amplifier 169 ate connected to the signal processing portions 122 and 133 (refer to FIG. 2), respectively.

The signal lines 161 and 165 (first line), and the signal lines 162 and 167 (second line) are paired with each other to constitute a differential signal line for differential transmission. Thus, the signal lines 161 and 165, and the signal lines 162 and 167 are electrically connected to the receiving amplifier 168 and the transmitting amplifier 169 as a differential communicating portion, respectively, in order to perform the data transmission through the HPD line 3J and the NC line 3K of the HDMI cable 3.

The switch 158 constitutes a driving portion including a switch 158A for connection of the signal line 161 to the power source V_{cc}, and a switch 158B for connection of the signal line 161 to GND. The switches 158A and 158B are driven by the microcomputer 156 described with reference to FIG. 3. The HPD signal having either the H level or the L level is outputted to the microcomputer 156 in accordance with the operations of the switches 158A and 158B. The output of the HPD signal made in accordance with operation patterns of the switches 158A and 158B is as shown in TABLE 1.

TABLE 1

Switch

| | | 158A | 158B |
|---|---|---|---|
| HPD signal | H | ON | OFF |
| | L | OFF | ON |

In this embodiment, the transmission of the data as a high frequency component, and the transmission for the HPD signal are carried out in different frequency bands, respectively, thereby using the HPD line 3J in common. The high frequency component, for example, has the band from 10 MHz to 1 GHz, and the HPD signal, for example, has the band of D.C. to 1 MHz.

Next, a description will be given with respect to an operation of the data transmitting system according to the first embodiment of the invention based on the operation of the information transmission path shown in FIG. 4A.

Firstly, when the digital signal, complying with the standard of IEEE802.3, which is outputted from a signal processing portion (not shown) is inputted to the transmitting amplifier 169 on the sink apparatus side (in the communicating portion 160), the transmitting amplifier 169 converts the digital signal into the differential signal, and transmits the resulting differential signal based on the digital signal to the source apparatus side (to the communicating portion 260) through the communication line 300.

The switch 158 performs an ON/OFF operation in order to urge the DVD recorder 20 as the source apparatus to execute some sort of processing when the state of the video receiving apparatus 10 as the sink apparatus changes, and so forth. The ON/OFF operation is performed by the switch 158 even when the data is transmitted from the sink apparatus side to the source apparatus side through the communication line 300.

Here, for ease of a description, the communicating portion 260 is separated from the communicating portion 160 on the sink apparatus side in the following description, and thus the communicating portion 160 is described. The switch 158 is connected in series with either the power source V_{cc} or GND through the resistor (R1) 158C. In this case, a circuit current path forms a circuit of the power source V_{cc}—the resistor (R2) 170—the capacitor (C2) 163—the resistor (R3) 164—the capacitor (C1) 166—the resistor (R1) 158C—the driving point (the switches 158A and 158B). Here, a momentarily flowing current (driving current) when the voltage at the driving point is changed in level from the power source V_{cc} to GND (from the H level to the L level), or from GND to the power source V_{cc} (from the L level to the H level) is expressed by V_{cc}/(R1+R2+R3). Also, a differential input voltage between the receiving amplifier 168 and the transmitting amplifier 169 is given by V_{cc}×R3/(R1+R2+R3).

Here, when R1=R2=1 kΩ, R3=50 Ω, and V_{cc}=5 V, the differential input voltage of 5×50/2,050 V=0.12 V is developed across the receiving amplifier 168 and the transmitting amplifier 169. Now, when the operable range of the differential communicating portion ranges from 2.0 V to 3.0 V, and a potential (operating voltage) developed across the resistor (R3) 164 is 2.5 V in a steady phase, this means that a change of ±0.12 V occurs in the potential developed across the resistor (R3) 164. In this embodiment, however, even when such a change occurs, it falls within the operable range of 2.0 to 3.0 V in the differential communicating portion described above. As a result, the receiving amplifier 168 and the transmitting amplifier 169 can normally operate. Likewise, the receiving amplifier 268 and the transmitting amplifier 269 of the communicating portion 260 on the source apparatus side can also normally operate.

FIG. 4B is a circuit diagram partially showing an information transmission path including an existing hot plug detection circuit.

An HDMI communicating portion 100A shown in FIG. 4B is different from the HDMI communicating portion 100 in this embodiment in that a communication line 165 is connected to the power source V_{cc} through a resistor (R1) 171, and in that the switch 158 is connected to GND without through the resistor. Thus, other portions of the HDMI communicating portion 100A shown in FIG. 4B are configured similarly to those of the HDMI communicating portion 100 in this embodiment.

In the HDMI communicating portion 100A shown in FIG. 4B, when the switch 158 is turned ON, the signal line 161 is connected to GND. At this time, the electric charges accumulated in the capacitor (C1) 166 provided in the middle of the signal line 165 connected to the signal line 161 are discharged to GND. As a result, a potential Vₚ₁ at a node P1 on the signal line 165 side becomes −(V_{cc}−Vₚ₁) For this reason, each of the differential inputs becomes beyond the operable range (a saturated region of the operation) of each of the receiving amplifier 168 and the transmitting amplifier 169. Thus, a transient state continues until Vₚ₁=Vₚ₂ in a steady state is obtained in a circuit of the power source (V_{cc})—the resistor (R2) 170—the capacitor (C2) 163—the resistor (R3) 164—the capacitor (C1) 166—GND. There is an inconvenience that although the differential communicating portion starts to normally operate when Vₚ₁ and Vₚ₂ become approximately equal to each other for this period of time, it can not normally operate until that time. For example, when V_{cc}=5 V, and Vₚ₁=2.5 V, the potential Vₚ₁ at the node P1 momentarily becomes −2.5 V, so that each of the differential inputs becomes beyond the operable range (the saturated region of the operation) of each of the receiving amplifier 168 and the transmitting amplifier 169.

In addition, when the switch 158 is turned OFF as a state shown in FIG. 4B from the ON state, the signal line 161 is disconnected from GND, and the capacitor (C1) 166 provided in the middle of the signal line 165 is charged with the electricity of the power source V_{cc} connected thereto through a resistor (R1) 171. In this case, a transient state continues until Vₚ₁=Vₚ₂ in the steady state is obtained in a circuit of the power source (V_{cc})—the resistor (R2) 170—the capacitor (C2) 163—the resistor (R3) 164—the capacitor (C1) 166—the resistor (R1) 171—the power source (V_{cc}). In this case, unlike the case where the switch 158 is turned ON from the OFF state, the differential voltage difference between the differential inputs to the differential communicating portions is expressed by a transient current ×R3 of the resistor 164. However, the transient current until the steady state is small because of addition of the resistor (R1) 171 to be beyond the operable range of each of the differential communicating portions. Therefore, the receiving amplifier 168, and the transmitting amplifier 169 can normally operate.

As has been described above, in the case of the information transmission path including the existing hot plug detecting circuit shown in FIG. 4B, there occurs a phenomenon that when the HPD signal is changed from the H level to the L level, each of the voltages of the signal lines 161 and 165 as one of the differential signal lines is reduced to be beyond the operable range, and the situation is caused in which the differential communicating portions can not operate, thereby interrupting the data transmission.

According to the first embodiment of the invention, the resistor (R1) 158C is connected in series between the switch 158 and the HPD line 3J in order to drive the HPD line 3J, which results in that the change in driving current is suppressed even when the driving point is switched from the power source V_{cc} to GND, or from GND to the power source V_{cc}. As a result, the receiving amplifier 168 and the transmitting amplifier 169 normally operate irrespective of the driving of the switch 158, which results in that the high speed two-way data transmission can be carried out at an arbitrary timing.

In addition, the data transmission between the communicating portion 160 and the communicating portion 260 through the communication line 300 can be carried out even when the HPD signal is changed from the H level to the L level, or from the L level to the H level without an interruption.

In addition, the data transmission can be continuously carried out without being interrupted even in the transient state caused by the situation that for example, the HPD signal is changed from the H level to the L level, or from the L level to the H level during the data transmission from the sink apparatus to the source apparatus. When the HPD signal is changed from the H level to the L level, although the data can not be transmitted from the source apparatus to the sink apparatus through the TMDS line, the data transmission can be carried out through the communication line 300 irrespective of the state of the HPD signal. For this reason, the high speed two-way data transmission becomes possible in which the state of the HPD signal is free from the restriction while there is kept the interchangeability in the transmission of the data complying with the HDMI standard.

For example, even when the HPD signal from the DVD recorder 20 connected to the video receiving apparatus 10 is held at the L level in FIG. 1, so that the video receiving apparatus 10 is not recognized as the sink apparatus from the DVD recorder 20, the communication line 300 of the HDMI cable 3 is in the state of allowing the data to be transmitted from the video receiving apparatus 10 to the DVD recorder 20 irrespective of the state of the HPD signal. For this reason, for example, the IPTV broadcasting signal inputted to the video receiving apparatus 10 through the Ethernet (registered trademark) cable 4 can be transmitted to the DVD recorder 20 through the communicating line 300 of the HDMI cable 3 to be recorded in the DVD recorder 20.

In addition, with regard to the data capable of being transmitted to the DVD recorder 20 through the communicating line 300 of the HDMI cable 3, in addition to the video signal described above, for example, any other suitable data such as a manipulation signal can be transmitted therethrough. Moreover, the data can be transmitted from the DVD recorder 20 side to the video receiving apparatus 10 at an arbitrary timing through the communication line 300. The data can be bi-directionally smoothly transmitted in the manner as described above, thereby extending the function.

In addition, according to the communication line 300 described above, even when the HPD signal is changed from the L level to the H level in the phase of the data transmission from the video receiving apparatus 10 to the DVD recorder 20, the impedance fluctuation in the communication line 300 can be suppressed so as to fall within the operable range of each of the receiving amplifier 167 and the transmitting amplifier 168. As a result, it is possible to realize the stable high speed data transmission.

### Second Embodiment

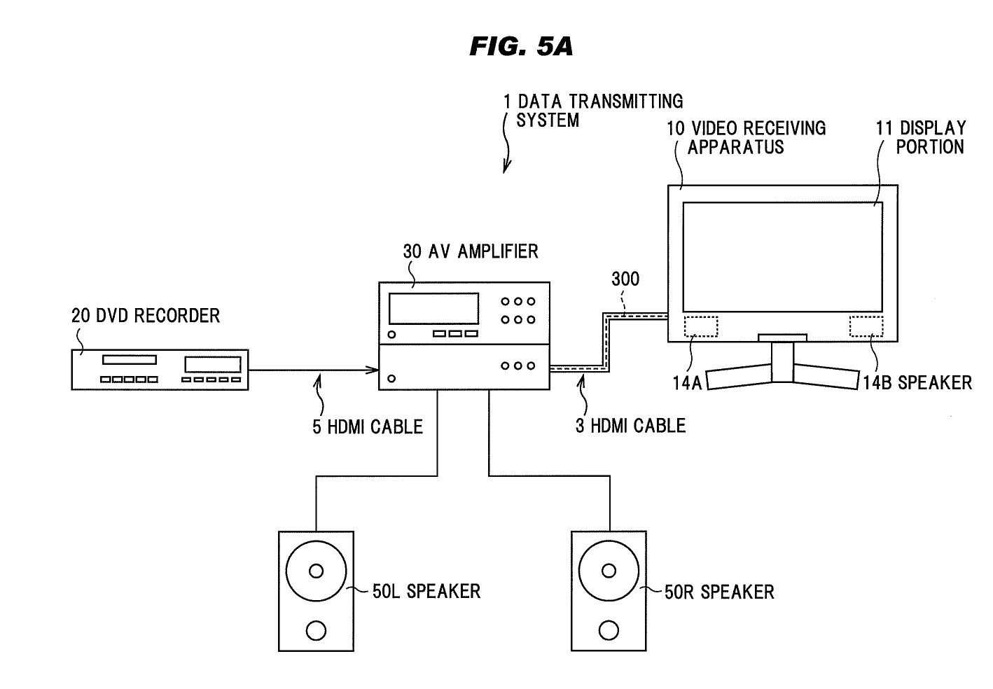

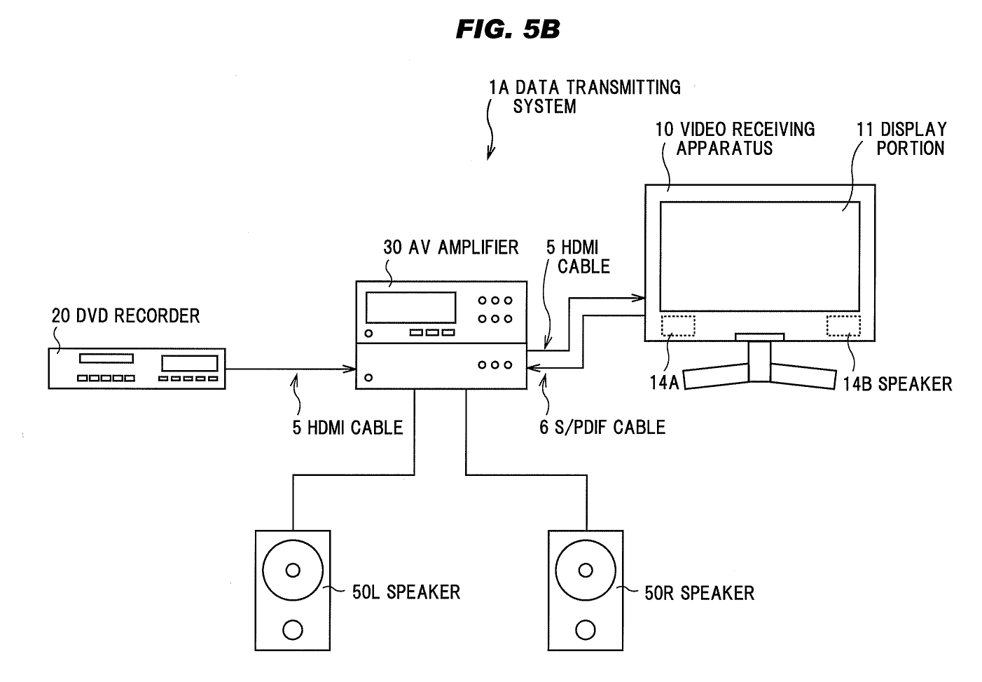

FIG. 5A is an overall view showing a data transmitting system according to a second embodiment of the present invention. It is noted that the communicating circuit between the source apparatus and the sink apparatus in the second embodiment is configured in the same manner as that in the communicating circuit previously described in the first embodiment. In the following description, portions having the same configurations and functions as those in the first embodiment are designated with the same reference numerals, respectively.

The data transmitting system 1 includes the video receiving apparatus (TV set) 10, the DVD recorder 20, an AV amplifier 30 connected to each of the video receiving apparatus 10 and the DVD recorder 20, and speakers 50L and 50R connected to the AV amplifier 30. Also, the DVD recorder 20 and the AV amplifier 30 are connected to each other through a normal HDMI cable 5, and the AV amplifier 30 and the video receiving apparatus 10 are connected to each other through the HDMI cable 3 having the communication line 300 previously described in the first embodiment.

Hereinafter, a description will be given with respect to the case where in the data transmitting system 1, a video signal is reproduced from the DVD by the DVD recorder 20, an image based on the video signal is displayed on the display portion 11 of the video receiving apparatus 10, and a sound is outputted from each of the speakers 50L and 50R connected to the AV amplifier 30.

The DVD recorder 20 outputs the video signal reproduced thereby from the DVD to the AV amplifier 30 through the HDMI cable 5. The AV amplifier 30 transmits the video signal transmitted thereto in the form of the serial data from the DVD recorder 20 to the video recording apparatus 10, and outputs the analog signal obtained through the extraction and the decoding of the serial data, to each of the speakers 50L and 50R. With such a system configuration, adjusting a volume or the like in the AV amplifier 30 makes it possible to output a sound, with a realistic sensation, fitted to the image displayed on the display portion 11 of the video recording apparatus 10.

Next, a description will be given with respect to the case where the television broadcasting signal is received by the video receiving apparatus 10, and a sound based on the television broadcasting signal is desired to be outputted from each of the speakers 50L and 50R through the AV amplifier 30.

In the data transmitting system 1, the audio signal is transmitted from the video receiving apparatus 10 to the AV amplifier 30 through the communication line 300 of the HDMI cable 3. The AV amplifier 30 outputs the analog audio signal based on the audio signal transmitted thereto to each of the speakers 50L and 50R. In this case, the audio signal can be stably transmitted irrespective of the state of the H level or the L level of the voltage signal of the HPD cable 3 connected between the video receiving apparatus 10 and the AV amplifier 30.

FIG. 5B is an overall view showing an example of a data transmitting system having no communication line existing therein described in the first embodiment.

In a data transmitting system 1A shown in FIG. 5B, the video recording apparatus 10 and the AV amplifier are connected to each other through the normal HDMI cable 5 instead of the HDMI cable 3 previously described with reference to FIG. 5A, and there a Sony/Philips Digital Interface Format (S/PDIF) cable 6 is provided through which the audio signal is transmitted from the video receiving apparatus 10 to the AV amplifier 30.

In the data transmitting system 1A, the audio signal is transmitted from the video receiving apparatus 10 to the AV amplifier 30 through the S/PDIF cable 6. For this reason, it is necessary to distribute at least two cables between the video receiving apparatus 10 and the AV amplifier 30, which results in that the cable connection becomes complicated.

According to the second embodiment of the invention, the audio signal can be transmitted from the video receiving apparatus 10 to the AV amplifier 30 irrespective of the state of the HPD signal because the video receiving apparatus 10 and the AV amplifier 30 are connected to each other through the HDMI cable 3 having the communication line 300 allowing the high speed two-way data transmission. It is noted that although in the second embodiment, the description has been given with respect to the operation for transmitting the video receiving apparatus 10 to the audio signal from the AV amplifier 30, the data contained in a control signal or the like can also be transmitted from the AV amplifier 30 to the video receiving apparatus 10 at an arbitrary timing through the communication line 300.

### Third Embodiment

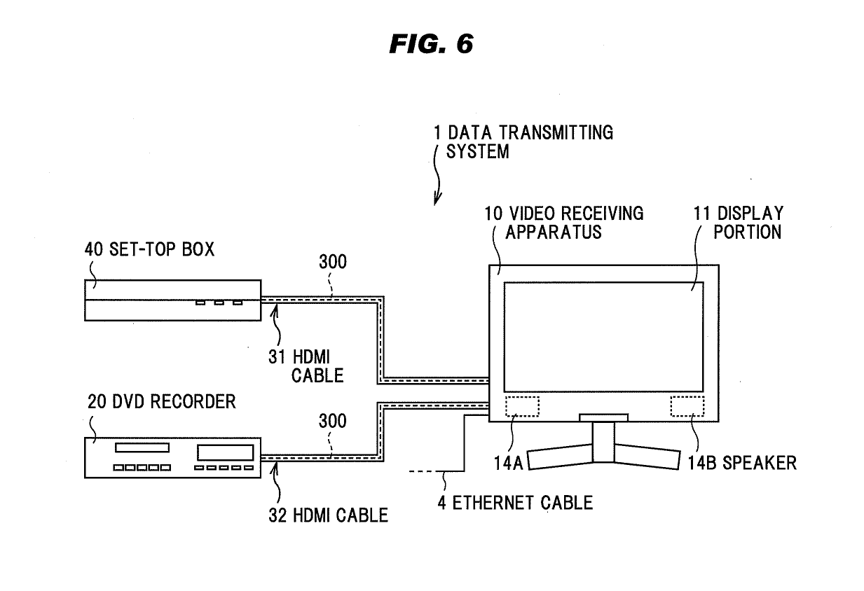

FIG. 6 is an overall view showing a data transmitting system according to a third embodiment of the invention. It is noted that the communicating circuit between the source apparatus and the sink apparatus in the third embodiment is configured in the same manner as that in the communicating circuit previously described in the first embodiment.

In the data transmitting system 1, the DVD recorder 20 and a set-top box 40 are connected to the video receiving apparatus 10 through HDMI cables 31 and 32, respectively. In addition, an Ethernet (registered trademark) cable 4 connected at its one terminal to the IP communication network is connected at its other terminal to the video receiving apparatus 10. In this embodiment, each of the DVD recorder 20 and the set-top box 40 is the source apparatus and the video receiving apparatus 10 is the sink apparatus.

It is supposed that in such an apparatus connection state, when seeing an image displayed on the display portion 11 of the video receiving apparatus 10, the user desires to record a program different from that containing the image being seen on the display portion 11. For example, this is the case where the program received by the set-top box 40 is recorded on a DVD in the DVD recorder 20 while the user sees the IPTV in the video receiving apparatus 10.

According to the third embodiment of the invention, in the video receiving apparatus 10, the compressed video signal transmitted from the set-top box 40 through the communication line 300 of an HDMI cable 31 is relayed and transmitted to the DVD recorder 20 through the communication line 300 of the HDMI cable 32. As a result, the DVD recorder 20 can record the video signal based on the program transmitted through the communication line 300 of the HDMI cable 31 and 32 on the DVD even when the user is seeing the image based on the signal, complying with the IPTV, which is displayed on the display portion 11 of the video receiving apparatus 10.

While the user sees the IPTV, each of the HPD signals on the HPD lines 3J of the HDMI cables 31 and 32 is driven at the L level. When the user switches the set-top box 40 from this state to the reproduction state, the HPD signal on the HPD line 3J of the HDMI cable 31 is driven at the H level, and the set-top box 40 decodes the received video signal and transmits the decoded video signal to the video receiving apparatus 10 through the MDMI cable 31. Even in such a case, the video receiving apparatus 10 can relay the compressed video signal which is transmitted thereto from the set-top box 40 through the communication line 30 of the HDMI cable 31. Therefore, the compressed video signal being transmitted from the video receiving apparatus 10 to the DVD recorder 20 through the communication line 300 of the HDMI cable 31 without being interrupted.

In the third embodiment, the data is transmitted from the set-top box 40 to the DVD recorder 20 when the user sees the image based on the signal, complying with the IPTV, which is displayed on the display portion 11 of the video recording apparatus 10. However, for example, even when the video recording apparatus 10 is in a standby state, the high speed two-way data transmission can also be carried out at an arbitrary timing between the set-top box 40 and the DVD recorder 20 as long as the communication line is data-transmittably connected.

### Other Embodiments

It is noted that the present invention is by no means limited to the embodiments described above and various changes can be made without departing from or changing the technical idea of the present invention.

What is claimed is:

1. A data transmitting apparatus, comprising:
a data transmitting circuit comprising:
a differential signal line through which a differential signal is transmitted and/or received by a first and a second line, wherein hot plug detection information of a communication line is transmitted through the first line and the second line is paired with the first line,
a hot plug-driving module for driving a signal on the first line so that a level of the signal is changed either to a Low level or to a High level, and
a differential communicating module connected to the differential signal line for transmitting the differential signal,
wherein the differential communicating module is configured to operate in an operable range when the signal level of the first line is changed from the Low level to the High level and from the High level to the Low level by the hot plug driving module; and
a signal processor configured to transmit and/or receive the differential signal through the data transmitting circuit.

2. A data transmitting apparatus of claim 1, wherein a first driving current that is supplied when a voltage of the first line is changed from a High level to a Low level is configured to be approximately matched to a second driving current that is supplied when the voltage of the first line is changed from the Low level to the High level while the hot plug driving module is driving the first line.

3. A data transmitting apparatus of claim 1, wherein the first line is connected to a power source or a ground line(GND) through a resistor, and is driven through the resistor while being connected to the power source or GND by the hot plug driving module.

4. A data transmitting apparatus of claim 1, wherein the operable range of the differential communicating module is configured to be wider than a fluctuation range of an operating voltage due to the change of the level of the signal on the first line from the Low level to the High level and from the High level to the Low level.

5. A data transmitting apparatus of claim 1, wherein the hot plug driving module is configured to transmit the hot plug detection information in a frequency band different from a frequency band used by the differential communicating module.

6. A data transmitting apparatus of claim 1, wherein the differential communicating module is operable while the hot plug driving module is in a standby state.

7. A data transmitting circuit, comprising:
a differential signal line through which a differential signal is transmitted and/or received by using a first and a second line, wherein hot plug detection information of a communication line is transmitted through the first line, and the second line is paired with the first line;
a hot plug driving module for driving a signal on the first line so that a level of the signal is changed either to a Low level or to a High level; and
a differential communicating module connected to the differential signal line for transmitting the differential signal;
wherein the differential communicating module is operated in an operable range when the level of the signal on the first line is changed from the Low level to the High level and from the High level to the Low level by the hot plug driving module.

8. A data transmitting circuit of claim 7, wherein a first driving current that is supplied when a voltage of the first line is changed from a High level to a Low level is configured to be approximately matched to a second driving current that is supplied when the voltage of the first line is changed from the Low level to the High level while the hot plug driving module is driving the first line.

9. A data transmitting circuit of claim 7, wherein the first line is connected to a power source or GND through a resistor, and is driven through the resistor while being connected to the power source or GND by the hot plug driving module.

10. A data transmitting circuit of claim 7, wherein the operable range of the differential communicating module is configured to be wider than a fluctuation range of an operating voltage due to the change of the level of the signal on the first line from the Low level to the High level and from the High level to the Low level.

11. A data transmitting circuit of claim 7, wherein the hot plug driving module is configured to transmit the hot plug detection information in a frequency band different from a frequency band used by the differential communicating module.

12. A data transmitting circuit of claim 7, wherein the differential communicating module is operable while the hot plug driving module is in a standby state.
